(19) United States
(12) Patent Application Publication
(10) Pub. No.: US 2012/0046943 A1
(43) Pub. Date: Feb. 23, 2012

(54) APPARATUS AND METHOD FOR IMPROVING COMMUNICATION QUALITY IN MOBILE TERMINAL

(75) Inventors: Nam-Woog LEE, Suwon-si (KR); Jae-Hyun KIM, Suwon-si (KR); Sang-Jin KIM, Suwon-si (KR); Baek-Kwon SON, Suwon-si (KR)

(73) Assignee: SAMSUNG ELECTRONICS CO. LTD., Suwon-si (KR)

(21) Appl. No.: 13/211,707

(22) Filed: Aug. 17, 2011

(30) Foreign Application Priority Data
Aug. 17, 2010 (KR) 10-2010-0079091

(51) Int. Cl. G10L 21/02; G10L 19/14

(52) U.S. Cl. 704/205; 704/201; 704/226; 704/225; 704/E21.002; 704/E19.039

(57) ABSTRACT

An apparatus and a method for voice communication of a mobile terminal are provided. More particularly, an apparatus and a method for clearly receiving a counterpart user's voice signal in a mobile terminal positioned at a place where a noise occurs are provided. The apparatus includes an input unit, an extension signal generator, and an adder. The input unit receives a voice signal. The extension signal generator generates, based on a voice signal received via the input unit, a harmonics signal corresponding to a frequency band that represents a reaction sensitive to a sense of hearing. The adder merges the generated harmonics signal with the received voice signal.

### PRIORITY

This application claims the benefit under 35 U.S.C. §119(a) of a Korean patent application filed in the Korean Intellectual Property Office on Aug. 17, 2010 and assigned Serial No. 10-2010-0079091, the entire disclosure of which is hereby incorporated by reference.

### BACKGROUND OF THE INVENTION

1. Field of the Invention

The present invention relates to an apparatus and a method for voice communication of a mobile terminal. More particularly, the present invention relates to an apparatus and a method for clearly receiving a counterpart user's voice signal in a mobile terminal located in a noisy environment.

2. Description of the Related Art

With the increasing distribution of a mobile terminal, particularly, a mobile terminal that enables wireless voice communication and information exchange, the mobile terminal has become ubiquitous in modern society. In an early stage of distribution of the mobile terminal, the mobile terminal was simply recognized as a terminal that can be carried to enable wireless telephone communication and schedule management, but as technology of the mobile terminal developed and a wireless Internet was introduced, the mobile terminal evolved beyond being used for only the purpose of simple telephone communication and schedule management. That is, the mobile terminal expanded its utilization range to include other functions such as a game function, a remote control function using short distance communication, and an image capturing function using a built-in camera, thereby meeting a user's need for additional functions.

While the mobile terminal will continue to provide even more additional functions, communication sound quality should also be improved because it is an essential function.

That is, a user performs communication using a mobile terminal under various environments, so that there is a great difference in communication quality actually perceived by a user. For example, in the case where a user performs communication in a noisy environment, clarity of a voice signal deteriorates and a user perceives that the communication quality reduces.

To address the above problem, the user may raise a communication volume of the mobile terminal to improve communication quality. The mobile terminal may analyzes a neighboring noise and control a gain of a voice signal depending on a result of the analysis.

The above method raises the intensity of a voice signal of the mobile terminal. When a gain value is excessively increased, the waveform of a voice signal may be distorted or clipped. In addition, the above method raises the intensity of a voice signal, so that a strange noise or a key tone note may occur during communication and damage a user's sense of hearing.

### SUMMARY OF THE INVENTION

Aspects of the present invention are to address at least the above-mentioned problems and/or disadvantages and to provide at least the advantages described below. Accordingly, an aspect of the present invention is to provide an apparatus and a method for improving clarity of a voice signal received by a mobile terminal.

Another aspect of the present invention is to provide an apparatus and a method for regenerating a voice signal received by a mobile terminal as a harmonics signal in a frequency band that serves as a basis of an equal loudness contour.

Still another aspect of the present invention is to provide an apparatus and a method for controlling the intensity of a harmonics signal depending on the strength of a neighboring noise in a mobile terminal.

In accordance with an aspect of the present invention, a voice communication apparatus of a mobile terminal is provided. The apparatus includes an input unit for receiving a voice signal, an extension signal generator for generating, based on the voice signal received via the input unit, a harmonics signal corresponding to a frequency band that represents a reaction sensitive to a sense of hearing, and an adder for merging the generated harmonics signal with the received voice signal.

In accordance with another aspect of the present invention, a voice communication method of a mobile terminal is provided. The method includes receiving a voice signal, generating, based on the received voice signal, a harmonics signal corresponding to a frequency band that represents a reaction sensitive to a sense of hearing, and merging the generated harmonics signal with the received voice signal.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating a voice signal processor of a mobile terminal for clearly receiving a user's voice signal according to an exemplary embodiment of the present invention;

FIG. 2 is a block diagram illustrating an extension signal generator for generating an extension signal according to an exemplary embodiment of the present invention;

FIG. 3 is a block diagram illustrating a gain determination unit for determining a degree of a neighboring noise according to an exemplary embodiment of the present invention;

FIG. 4 is a flowchart illustrating a process for clearly receiving a voice signal in a mobile terminal according to an exemplary embodiment of the present invention;

FIG. 5 is a flowchart illustrating a process for generating an extension signal in a mobile terminal according to an exemplary embodiment of the present invention;

FIG. 6 is a flowchart illustrating a process for determining the strength of a neighboring noise in a mobile terminal according to an exemplary embodiment of the present invention;

FIG. 7 is a view illustrating an equal loudness contour used for improving clarity of a voice signal in a mobile terminal according to an exemplary embodiment of the present invention;

FIG. 8 is a graph illustrating a process for determining a gain value depending on a neighboring noise strength in a mobile terminal according to an exemplary embodiment of the present invention; and

FIG. 9 is a view comparing operation processes of a mobile terminal according to an exemplary embodiment of the present invention and a mobile terminal according to the related art.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention provide an apparatus and a method for improving clarity of a received voice signal by regenerating the voice signal received in a mobile terminal as a harmonics signal in a band that can be heard by a user based on an equal loudness contour.

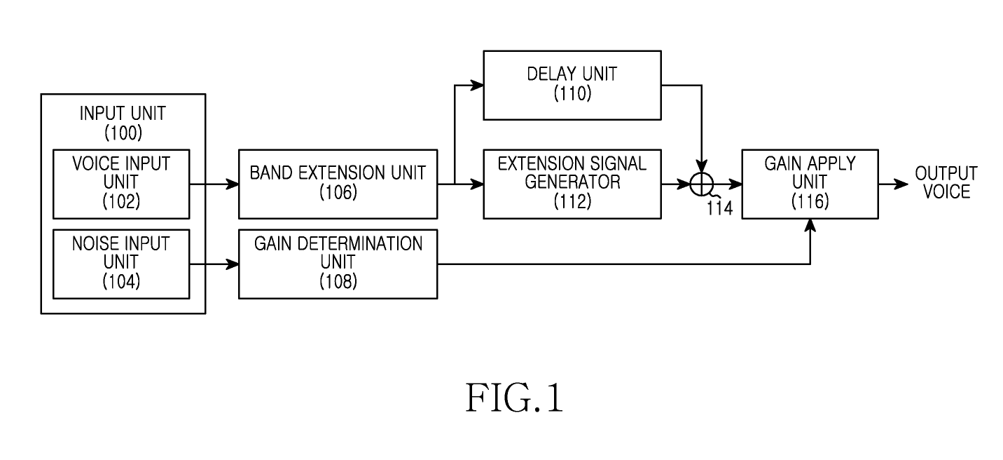

FIGS. 1 through 9, described below, and the various exemplary embodiments of the present invention provided are by way of illustration only and should not be construed in any way that would limit the scope of the present invention. Those skilled in the art will understand that the principles of the present disclosure may be implemented in any suitably arranged communications system. The terms used to describe various exemplary embodiments of the present invention provided to merely aid the understanding of the description, and that their use and definitions in no way limit the scope of the invention. Terms first, second, and the like are used to differentiate between objects having the same terminology and are in no way intended to represent a chronological order, unless where explicitly state otherwise. A set is defined as a non-empty set including at least one element.

FIG. 1 is a block diagram illustrating a voice signal processor of a mobile terminal for clearly receiving a user's voice signal according to an exemplary embodiment of the present invention.

Referring to FIG. 1, the voice signal processor includes an input unit 100, a band extension unit 106, a gain determination unit 108, a delay unit 110, an extension signal generator 112, an adder 114, and a gain apply unit 116. The input unit 100 may include a voice input unit 102 and a noise input unit 104.

First, the input unit 100 receives a voice signal for improving clarity.

That is, the voice input unit 102 of the input unit 100 receives a voice signal transmitted from a counterpart mobile terminal. The voice input unit 102 improves clarity of the voice signal by providing the received voice signal to the band extension unit 106.

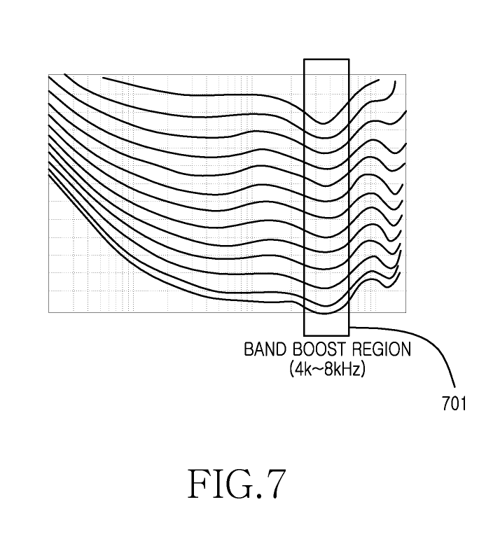

The band extension unit 106 that receives the voice signal converts the received voice signal into a signal of an upper sampling frequency, and provides the converted signal to the extension signal generator 112. This is to convert the received voice signal into a signal of the upper sampling frequency using a fact that a user sensitively reacts to a voice signal in a frequency band of 4 KHz or more rather than a voice signal in a frequency band of less than 4 KHz (sensitive band) as in the equal loudness contour illustrated in FIG. 7 (described further below). For example, an input signal to which a person does not react sensitively (for example, an input signal of a 8 KHz sampling rate frequency) is received from the voice signal input unit 102, the band extension unit 106 determines that a signal not including a sensitive band of the equal loudness contour has been received and performs sampling frequency conversion to a voice signal in a frequency band (for example, 16 KHz) to which a person sensitively reacts on the received input signal. Conversely, in the case where an input signal of 16 KHz is received from the voice signal input unit 102, the band extension unit 106 determines that it has received a broadband signal including a sensitive band of the equal loudness contour to provide the received voice signal to the extension signal generator 112.

The extension signal generator 112 that has received the broadband signal including the sensitive band of the equal loudness contour generates an extension signal and then merges the received voice signal with the generated extension signal via the adder 114 to improve clarity of a counterpart user's voice signal.

The extension signal serves as a signal for improving clarity of the counterpart user's voice signal, and denotes a harmonics signal that does not include a low band region of a band limit frequency or less of the received voice signal.

At this point, an extension signal generated by the extension signal generator 112 is merged with the voice signal via a synchronization process of the delay unit 110. Therefore, in the case where generation of an extension signal is delayed due to a process delay of the extension signal generator 112, a problem that the extension signal may not be synchronized with the voice signal is addressed.

The voice signal merged with the extension signal has an increased volume of the voice signal and simultaneously becomes a signal having an emphasized sensitive band due to the addition of the extension signal, so that clarity of the voice signal improves.

The voice signal processor improves clarity of the voice signal using the extension signal, but according to an exemplary embodiment of the present invention, the voice signal processor may control the voice signal to which the extension signal has been added depending on a degree of the neighboring noise. That is, the voice signal processor provides a noise input to the noise input unit 104 to the gain determination unit 108 to determine a degree of noise in the environment where the mobile terminal is located. The gain determination unit 108 analyzes the input noise to determine a gain for controlling the voice signal to which the extension signal has been added, and then provides the same to the gain apply unit 116.

Accordingly, the gain apply unit 116 controls the voice signal to which the extension signal has been added using the gain provided from the gain determination unit 108 to improve clarity of the voice signal.

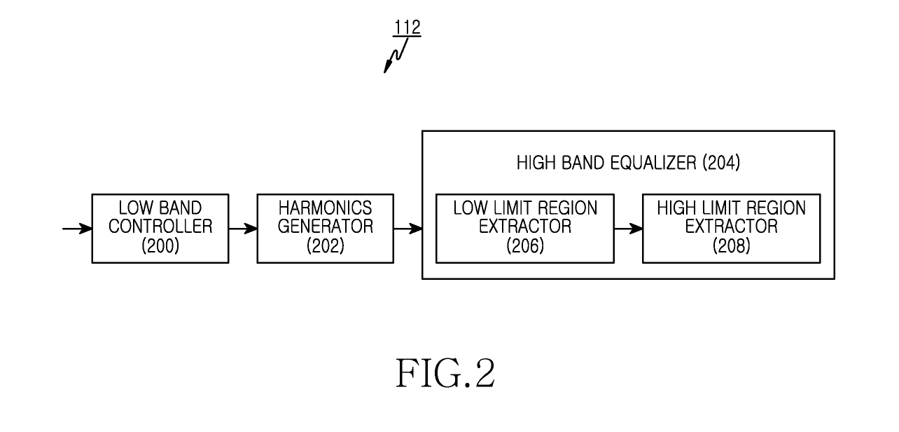

FIG. 2 is a block diagram illustrating an extension signal generator for generating an extension signal according to an exemplary embodiment of the present invention.

Referring to FIG. 2, the extension signal generator 112 may include a low band controller 200, a harmonics generator 202, and a high band equalizer 204.

The low band controller 200 removes a low band portion of the signal converted into the signal of the upper sampling frequency by the band extension unit 106, that is, the broadband signal including the sensitive band of the equal loudness contour, and then provides the same to the harmonics generator 202. This is to reduce a low band portion of the extension signal which is a harmonics band for improving clarity in order to address a problem that a counterpart user's voice signal is mistaken as a noise when heard in the case where a low frequency signal occupies a large portion in the counterpart user's voice signal.

The harmonics generator 202 generates a harmonics signal of an extension signal whose low band portion has been reduced. The high band equalizer 204 controls a harmonics signal excessively generated by the harmonics generator 202 using a weighting filter.

The high band equalizer 204 includes a low limit region extractor 206 and an upper limit region extractor 208. The high band equalizer 204 extracts a low limit region signal of the harmonics signal using a first weighting filter corresponding to the low limit region extractor 206.

In the case where the high band equalizer 204 performs equalization by dividing the band into two frequency bands for example, assuming that a band limit frequency of a voice signal is fc, a low limit region of the harmonics signal becomes a region ranging from fc to 1.5fc.

In addition, the high band equalizer 204 extracts an upper limit region of the harmonics signal corresponding to a region ranging from 1.5fc to 2.0fc using a second weighting filter corresponding to the upper limit region extractor 208. The number of frequency bands of the high band equalizer 204 may be increased or reduced depending on the case.

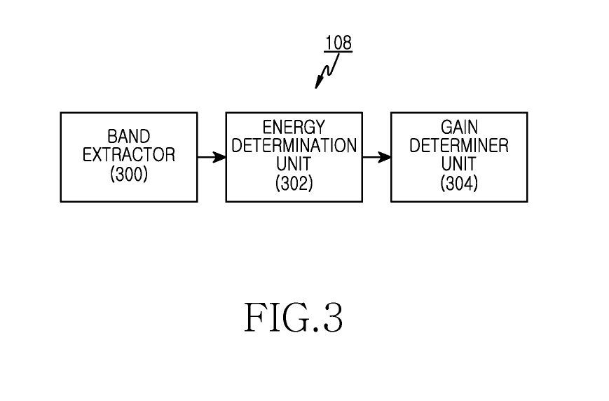

FIG. 3 is a block diagram illustrating a gain determination unit for determining a degree of a neighboring noise according to an exemplary embodiment of the present invention.

Referring to FIG. 3, the gain determination unit 108 may include a band extractor 300, an energy determination unit 302, and a gain determiner unit 304.

The band extractor 300 divides an input noise into frequency bands. The band extractor 300 includes a first signal extractor (e.g., a low frequency band noise extractor) for extracting only a noise distributed below a low band upper limit frequency f_{lower} from the input noise signal, and a second signal extractor (e.g., a high frequency band noise extractor) for extracting only a signal of a high band low limit frequency fᵤₚₚₑᵣ or more.

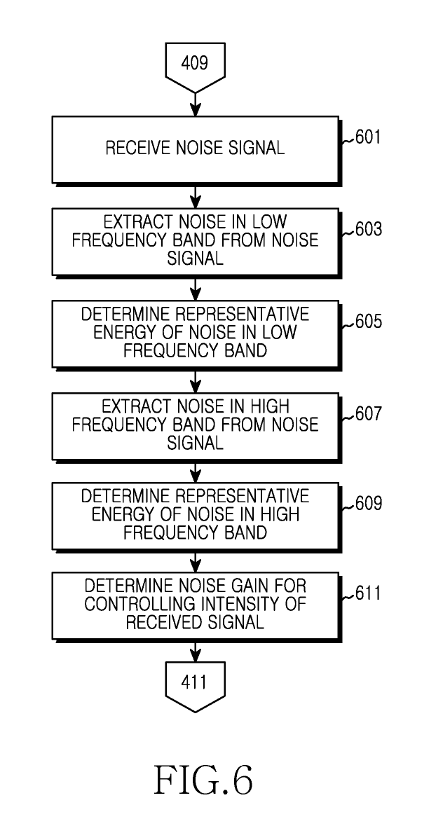

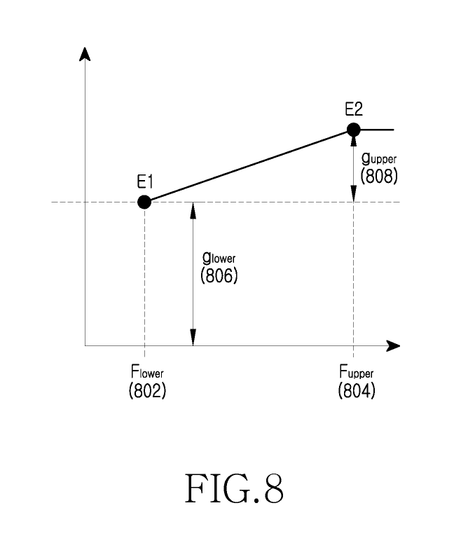

When a noise is divided for each band by the band extractor 300, the energy determination unit 302 determines a low frequency band representative energy value and a high frequency band representative energy value. The gain determiner unit 304 determines a gain value for each frequency corresponding to a noise degree using the representative energy determined by the energy determination unit 301. The gain value corresponding to the noise degree denotes a value for controlling the intensity of a signal to which an extension signal has been added depending on a neighboring noise degree, which will be descried in more detail with reference to FIGS. 6 and 8.

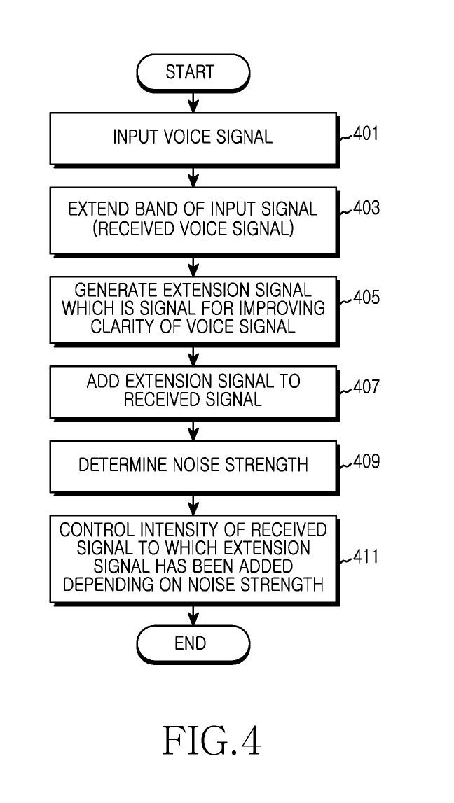

FIG. 4 is a flowchart illustrating a process for clearly receiving a voice signal in a mobile terminal according to an exemplary embodiment of the present invention.

Referring to FIG. 4, the mobile terminal receives a counterpart user's voice signal in step 401, and proceeds to step 403 to extend the band of the voice signal received in step 401.

Here, the mobile terminal converts the counterpart user's voice signal into a broadband signal including a sensitive band using a fact that a user sensitively reacts to a voice signal in a frequency band of 4 KHz or more rather than a voice signal in a frequency band of less than 4 KHz (sensitive band) as in the equal loudness contour shown in FIG. 7.

The mobile terminal proceeds to step 405 to generate an extension signal using a broadband signal including the sensitive band. Here, the extension signal serves as a signal for improving clarity of a counterpart user's voice signal, and denotes a harmonics signal in which a low band region of the input voice signal has been removed.

The mobile terminal proceeds to step 407 to merge the voice signal received in step 401 with the extension signal generated in step 405, thereby improving clarity of the voice signal.

At this point, the mobile terminal may prevent synchronism between the voice signal and the extension signal from being destroyed due to a delay of the extension signal generation by performing a synchronization process on the voice signal and the extension signal.

The mobile terminal that has improved clarity of the voice signal proceeds to step 409 to determine the strength of a noise occurring in the neighborhood in which the mobile terminal is located, and then proceeds to step 411 to control the intensity of the input signal to which the extension signal has been added in step 407 depending on the strength of the neighboring noise.

As described above, the mobile terminal may improve clarity of a voice signal by adding the extension signal to the voice signal to increase the volume of the voice signal and simultaneously regenerate the voice signal as a signal where the sensitive band has been emphasized.

After that, the mobile terminal ends the present algorithm.

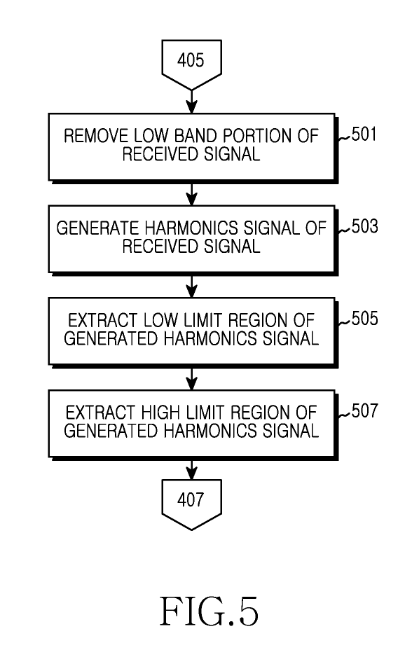

FIG. 5 is a flowchart illustrating a process for generating an extension signal in a mobile terminal according to an exemplary embodiment of the present invention.

Referring to FIG. 5, the mobile terminal for generating the extension signal removes a low band portion of an input signal in step 501. This is for solving a problem that a counterpart user's voice signal is mistaken as an unpleasant noise when heard in the case where a low frequency signal occupies a large portion in the voice signal. This is to reduce the low band portion of the extension signal which is a harmonics signal for improving clarity.

The mobile terminal proceeds to step 503 to generate a harmonics signal of the input signal whose low band portion has been reduced.

The mobile terminal may generate the harmonics signal via a non-linear operation, and perform an equalization process using a weighting filter on an excessive harmonics signal in order to prevent a sound quality of a voice signal from being distorted due to the excessive harmonics signal. The mobile terminal extracts a region on which the equalization process is to be performed using a weighting filter. That is, the mobile terminal extracts a low limit region of the generated harmonics signal in step 505, and extracts a high limit region of the generated harmonics signal in step 507.

After that, the mobile terminal proceeds to step 407 of FIG. 4.

FIG. 6 is a flowchart illustrating a process for determining the strength of a neighboring noise in a mobile terminal according to an exemplary embodiment of the present invention.

Referring to FIG. 6, the mobile terminal receives a noise signal in step 601, and then divides the received noise signal into frequency bands.

That is, the mobile terminal proceeds to step 603 to extract only a noise distributed below a low band upper limit frequency f_{lower} from the received noise signal, and then proceeds to step 605 to determine a low frequency band representative energy value E1 of the received noise signal.

In addition, the mobile terminal proceeds to step 607 to extract only a signal of a high band lower limit frequency fᵤₚₚₑᵣ or more from the received noise signal, and then proceeds to step 609 to determine a representative energy value E2 of a high band noise of the received signal.

At this point, the mobile terminal may determine the representative energy using Root Mean Square (RMS) power.

The mobile terminal proceeds to step 611 to determine a noise gain for each frequency for controlling the intensity of the received signal using representative energies corresponding to the determined high band noise and low band noise. Here, the noise gain denotes a value for controlling a voice signal to which an extension signal has been added depending on a neighbor noise degree. The mobile terminal may improve clarity of the voice signal by controlling a gain optimized for each frequency band of an output voice signal depending on a frequency characteristic of a noise based on the representative energy value. This is for addressing a problem of the mobile terminal that determines a gain value suitable for one of a low frequency band, an intermediate frequency band, and a high frequency band.

FIG. 7 is a view illustrating an equal loudness contour used for improving clarity of a voice signal in a mobile terminal according to an exemplary embodiment of the present invention.

Referring to FIG. 7, as illustrated in the equal loudness contour, a person's ear reacts more sensitively to the same volume in a frequency band of more than 4 KHz rather than a frequency band of 4 KHz or less where most of voice signals are distributed.

Defining a frequency band 701 of 4 KHz˜8 KHz where a person sensitively reacts in an aspect of the sense of hearing is a sensitive band, exemplary embodiments of the present invention generate a harmonics signal of a received signal not including the sensitive band of the equal loudness contour to generate the signal as a received signal including the sensitive band.

FIG. 8 is a graph illustrating a process for determining a gain value depending on a neighboring noise strength in a mobile terminal according to an exemplary embodiment of the present invention.

Referring to FIG. 8, the mobile terminal analyzes a received noise and divides the noise into frequency bands.

That is, the mobile terminal extracts only a noise distributed below a low band upper limit frequency f_{lower} 802 from the received noise signal to determine a low frequency band representative energy value E1 of the received noise signal, and extracts only a signal of a high band lower limit frequency fᵤₚₚₑᵣ 804 or more from the received noise signal to determine a representative energy value E2 of a high band noise of the received signal. An intermediate band noise representative energy value between the low band upper limit frequency f_{lower} and the high band lower limit frequency fᵤₚₚₑᵣ is obtained by performing linear interpolation based on the determined E1 and E2.

Accordingly, the mobile terminal may determine each gain value using the high band lower limit frequency and the low band upper limit frequency. The intermediate frequency band gain value is interpolated according to a slope depending on a deviation of the gain to determine a noise gain value for controlling the intensity of a received signal. That is, a mobile terminal according to an exemplary embodiment of the present invention determines a noise degree that depends on each frequency band, determines a gain value optimized for a low frequency band, a gain value optimized for an intermediate frequency band, and a gain value optimized for a high frequency band to improve clarity of a voice signal. The mobile terminal determines a lower limit gain g_{lower} 806 of the low frequency band based on the noise energy E1 of the extracted low band upper limit frequency or less (g and determines the upper limit gain gᵤₚₚₑᵣ 808 based on the noise energy E2 of the high band lower limit frequency or more (gᵤₚₚₑᵣ=f(E2)). The mobile terminal determines the gain value of the intermediate band between the lower limit frequency and the upper limit frequency by performing linear interpolation depending on a difference between the noise energy E1 below the low band upper limit frequency and the noise energy E2 existing above the high band lower limit frequency (g_{mid}=f(E1−E2)).

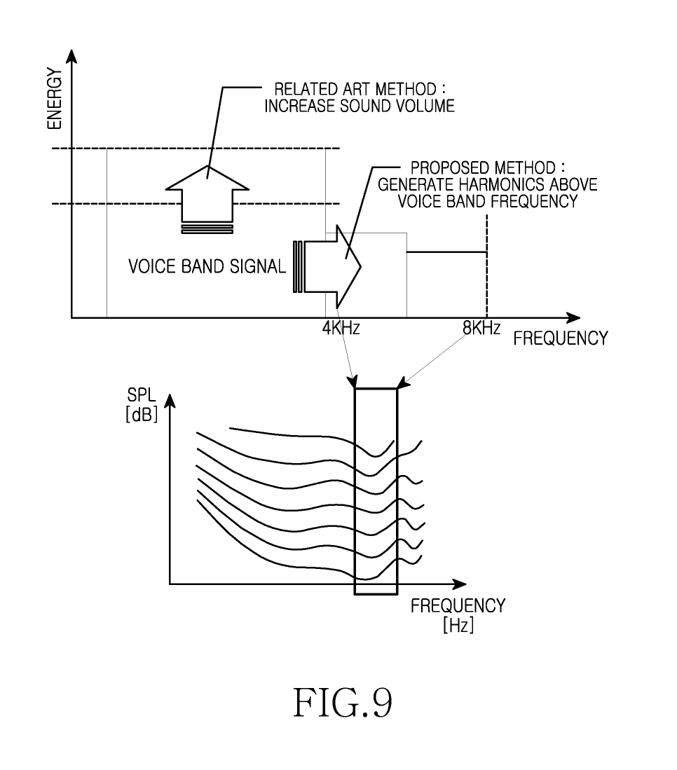

FIG. 9 is a view comparing operation processes of a mobile terminal according to an exemplary embodiment of the present invention and a mobile terminal according to the related art.

Referring to FIG. 9, the mobile terminal of the related art analyzes a neighboring noise in real-time in order to raise a communication quality in an environment where a noise occurs, and then automatically controls a gain value of a communication note (voice signal) depending on the analyzed neighboring noise to automatically increase a sound volume.

However, exemplary embodiments of the present invention generate a communication note as a harmonics signal corresponding to a frequency band representing a reaction sensitive to the sense of hearing to allow a user to clearly recognize the communication note.

As described above, exemplary embodiments of the present invention allow a mobile terminal positioned at a place where a noise occurs to regenerate a received voice signal as a harmonics signal of a frequency band that serves as a basis of the equal loudness contour in order to clearly receive a counterpart user's voice signal, thereby clearly receiving the counterpart user's voice signal regardless of a neighboring noise.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A voice communication apparatus of a mobile terminal, the apparatus comprising:
an input unit for receiving a voice signal;
an extension signal generator for generating, based on the voice signal received via the input unit, a harmonics signal corresponding to a frequency band that represents a reaction sensitive to a sense of hearing; and
an adder for merging the generated harmonics signal with the received voice signal.

2. The apparatus of claim 1, wherein the input unit comprises:
a voice input unit for receiving the voice signal; and
a noise input unit for receiving a neighboring noise signal.

3. The apparatus of claim 1, wherein the extension signal generator receives an input signal whose frequency band has been extended, removes a low frequency band portion of the input signal whose frequency band has been extended, and generates a harmonics signal of the input signal whose low frequency band portion has been removed.

4. The apparatus of claim 3, wherein, after the generating of the harmonics signal, the extension signal generator extracts an upper limit region and a lower limit region of the harmonics signal to perform an equalization process.

5. The apparatus of claim 1, further comprising:
a gain determination unit for determining a gain to be applied to the voice signal merged by the adder; and
a gain apply unit for controlling the voice signal merged by the adder according to the gain determined by the gain determination unit depending on an intensity of a neighboring noise signal.

6. The apparatus of claim 5, wherein the gain determination unit divides a received noise signal for each frequency band to determine a noise gain for controlling an intensity of the received signal.

7. The apparatus of claim 6, wherein the gain determination unit divides the received noise signal for each frequency band by dividing the received noise signal into a noise in a low frequency band and a noise in a high frequency band.

8. The apparatus of claim 6, wherein the gain determination unit sets a gain value optimized for each divided frequency band.

9. The apparatus of claim 1, wherein the adder performs a synchronization process on the voice signal and the harmonics signal.

10. A voice communication method of a mobile terminal, the method comprising:
receiving a voice signal;
generating, based on the received voice signal, a harmonics signal corresponding to a frequency band that represents a reaction sensitive to a sense of hearing; and
merging the generated harmonics signal with the received voice signal.

11. The method of claim 10, wherein the generating of the received voice signal as the harmonics signal corresponding to the frequency band that represents the reaction sensitive to the sense of hearing comprises:
extending the received signal;
removing a low frequency band portion of the extended received signal; and
generating a harmonics signal of the received signal whose low frequency band portion has been removed.

12. The method of claim 11, further comprising, after the generating of the harmonics signal, extracting an upper limit region and a lower limit region of the harmonics signal to perform an equalization process.

13. The method of claim 10, further comprising controlling the voice signal merged with the generated harmonics signal depending on a strength of a neighboring noise signal.

14. The method of claim 13, wherein the controlling of the voice signal merged with the generated harmonics signal depending on the strength of the neighboring noise signal comprises:
receiving a noise signal;
dividing the received noise signal for each frequency band; and
determining a noise gain for controlling an intensity of the received signal using the noise signal divided for each frequency band.

15. The method of claim 14, wherein the dividing of the received noise signal for each frequency band comprises:
dividing the received noise signal into a noise in a low frequency band and a noise in a high frequency band.

16. The method of claim 14, wherein the determining of the noise gain for controlling the intensity of the received signal comprises:
determining a representative energy corresponding to the each divided frequency band; and
setting a gain value optimized for the each divided frequency band using the determined representative energy.

17. The method of claim 10, wherein the merging of the generated harmonics signal with the received voice signal comprises:
synchronizing the voice signal with the harmonics signal.
